(19) United States
(12) Patent Application Publication
(10) Pub. No.: US 2007/0044600 A1
(43) Pub. Date: Mar. 1, 2007

(54) Wrench set having driving members with specific sizes

(76) Inventor: Terence Chen, Ilan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/212,635

(22) Filed: Aug. 29, 2005

(51) Int. Cl. B25B 13/58; B25B 13/00; B25B 23/16; B25G 1/00

(52) U.S. Cl. 81/185; 81/124.4; 81/177.85

(57) ABSTRACT

A wrench includes a handle and two function heads on two ends of the handle. Two engaging holes are respectively defined in the two function heads so as to be engaged with two driving members. Each of the two driving members includes an engaging section for being engaged with the engaging hole and a polygonal driving portion which extends from the engaging section. The sizes of the two engaging sections can be 10 mm (⅜ inch) and 13 mm (½ inch), 10 mm (⅜ inch) and 19 mm (¾ inch), or 13 mm (½ inch) and 19 mm (¾ inch).

### FIELD OF THE INVENTION

The present invention relates to a wrench set which includes three driving members with specific sizes which are 10 mm, 13 mm and 19 mm or ⅜ inch, ½ inch and ¾ inch.

### BACKGROUND OF THE INVENTION

A conventional wrench set includes several operation sizes which have a commonly known sequence so as to be cooperated with objects of different sizes. However, the commonly known sockets that can be cooperated with different driving members of wrenches includes three specific sizes which are 10 mm, 13 mm and 19 mm or ⅜ inch, ½ inch and ¾ inch. In other words, the users can only pick the conventional wrenches having the three specific sizes so as to connect the sockets. Therefore, the users have to find out the specific wrenches among the wrenches in the tool box. Although some wrenches have two function heads each have a driving member, they are not made to include the consideration of the specific sizes of the sockets as mentioned.

The present invention intends to provide a wrench set that include three driving members which can respectively cooperate with sockets of 10 mm, 13 mm and 19 mm or ⅜ inch, ½ inch and ¾ inch.

### SUMMARY OF THE INVENTION

The present invention relates to a wrench comprising a handle and two function heads on two ends of the handle. Two engaging holes are respectively defined in the two function heads. Two of three driving members are engaged with the engaging holes. Each of the three driving members has an engaging section for being engaged with the engaging hole and a polygonal driving portion extends from the engaging section. The three respective engaging sections have three respective sizes of 10 mm (⅜ inch), 13 mm (½ inch) and 19 mm (¾ inch).

The primary object of the present invention is to provide a wrench having different sizes of driving members connected to two respective function heads of the wrench so as to cooperate with sockets or the like of different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the wrench and a driving member of the present invention;

FIG. 2 is a side view to show the wrench and the driving member of the present invention;

FIG. 3 shows the three sizes of the driving members to be connected with the wrench of the present invention;

FIG. 4 shows three wrenches with the corresponding driving members;

FIG. 5 shows another embodiment of the wrench cooperated with three driving members;

FIG. 6 shows that the function heads are not cooperated with ratchet mechanisms, and

FIG. 7 shows that the wrench can also have only one function head.

### DETAILED DESCRIPTION OF THE PREFERRED EMBODIMENT

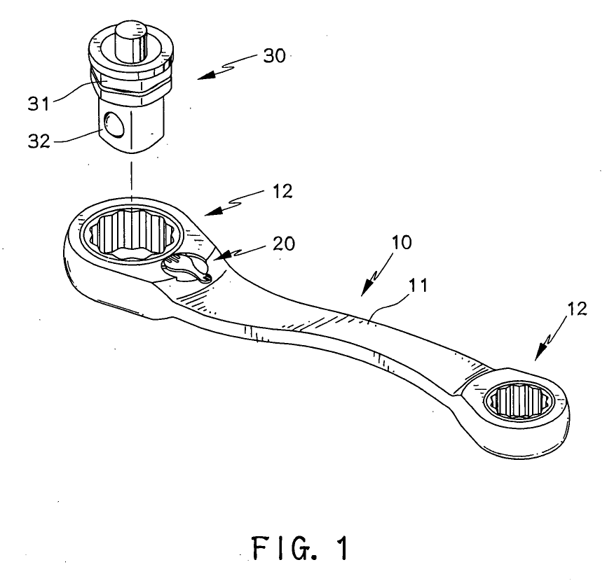

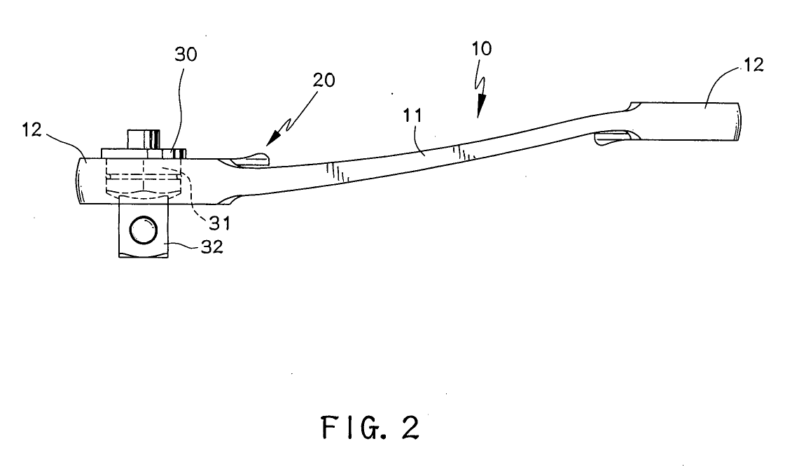

Referring to FIGS. 1 and 2, the wrench 10 of the present invention comprises a handle 11 and two function heads 12 are connected on two ends of the handle 11. Two engaging holes are respectively defined in the two function heads 12 and two driving members 30 are engaged with the two engaging holes. Each of the driving members 30 has an engaging section 31 for being engaged with the engaging hole and a polygonal driving portion 32 which extends from the engaging section 31. The driving portion 32 is to be engaged with a socket, for example. The two, driving member 30 have different sizes and each of the two function heads 12 includes a ratchet mechanism connected thereto so as to control the direction of rotation to output torque.

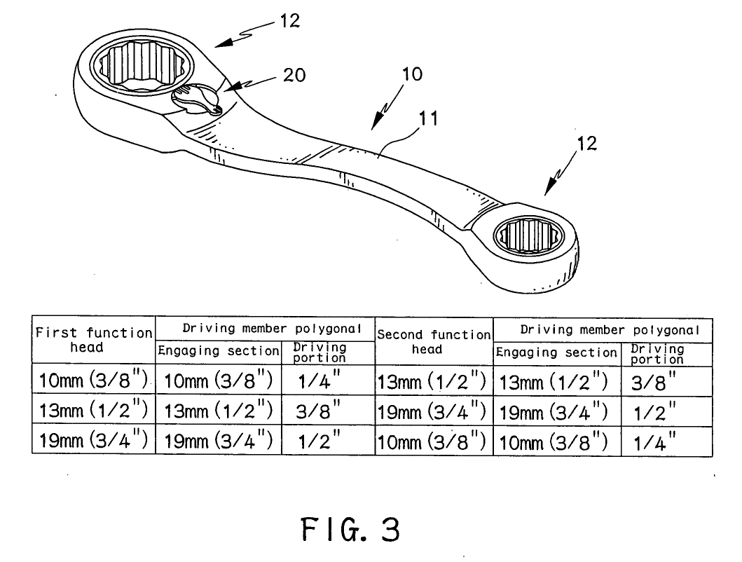

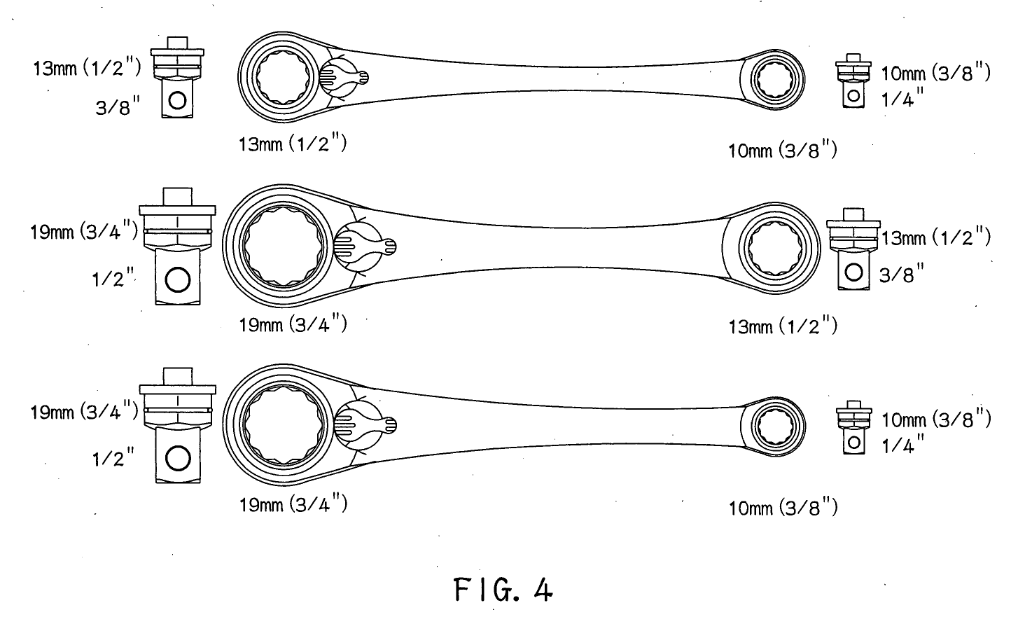

As shown in FIG. 3 which discloses the different pairs of driving members 30 of different sizes to be connected to the two function heads 12 of the wrench of the present invention. As shown in FIG. 4, the present invention can be made in a form of a wrench set including three wrenches which are a first wrench, a second wrench and a third wrench. The first wrench has a first handle and two first function heads on two ends of the first handle. Two first engaging holes are respectively defined in the two first function heads. Two first driving members each have a first engaging section and a first polygonal driving portion extending from the first engaging section corresponding thereto. The two respective first engaging sections are engaged with the two first engaging holes respectively. The two respective first engaging sections are sized to be 10 mm (⅜ inch) and 13 mm (½ inch).

The second wrench have a second handle and two second function heads on two ends of the second handle. Two second engaging holes are respectively defined in the two second function heads. Two second driving members each have a second engaging section and a second polygonal driving portion extending from the second engaging section corresponding thereto. The two respective second engaging sections are engaged with the two second engaging holes respectively. The two respective second engaging sections are sized to be 13 mm (½ inch) and 19 mm (¾ inch).

The third wrench has a third handle and two third function heads on two ends of the third handle. Two third engaging holes are respectively defined in the two third function heads. Two third driving members each have a third engaging section and a third polygonal driving portion extending from the third engaging section corresponding thereto. The two respective third engaging sections are engaged with the two third engaging holes respectively. The two respective third engaging sections are sized to be 19 mm (¾ inch) and 10 mm (⅜ inch).

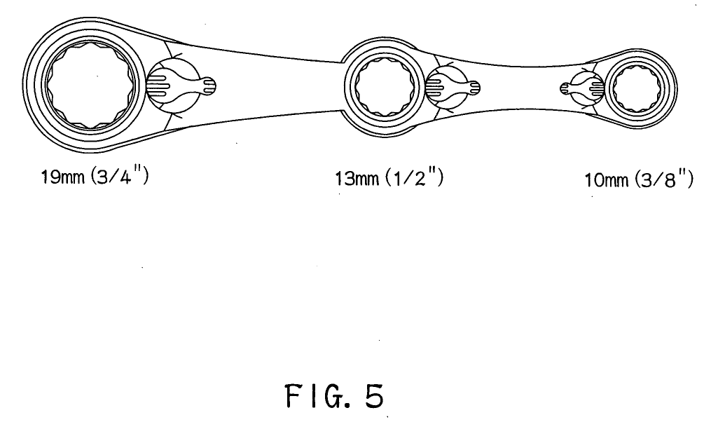

FIG. 5 shows yet another embodiment of the present invention, wherein the wrench has a handle which has a first function head and a second function head connection on two ends thereof. A first engaging hole (19 mm (¾ inch)) and a second engaging hole (10 mm (⅜ inch)) are respectively defined in the first and second function heads. A third engaging hole (13 mm (½ inch)) is defined through the handle. The three engaging holes are respectively cooperated with three driving members with three respective sizes of 19 mm (¾ inch), 10 mm (⅜ inch), and 13 mm (½ inch).

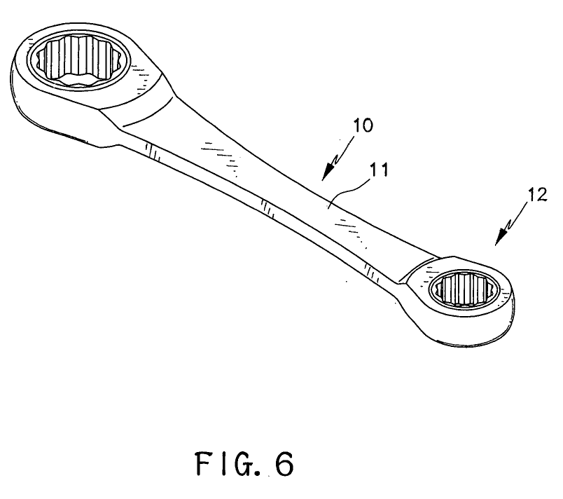

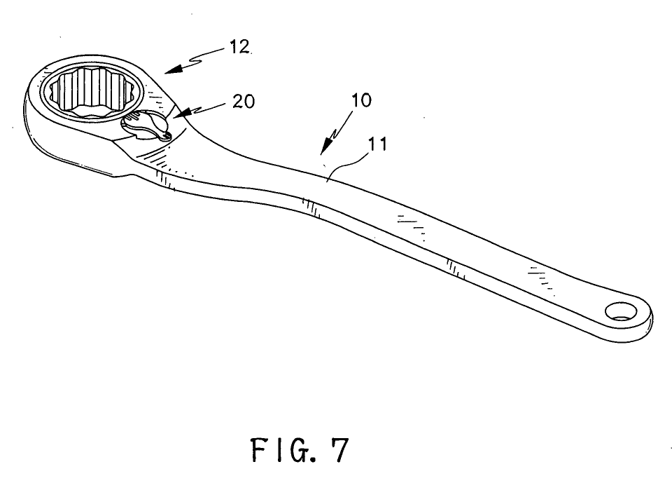

FIG. 6 shows that there is no ratchet mechanism to be connected with the wrench of the present invention so that only one direction of rotation of the handle can output torque. FIG. 7 shows that the wrench can have only one function head 12 as shown.

While we have shown and described the embodiment in accordance with the present invention, it should be clear to those skilled in the art that further embodiments may be made without departing from the scope of the present invention.

What is claimed is:

1. A wrench set comprising:
a first wrench having a first handle and two first function heads on two ends of the first handle, two first engaging holes respectively defined in the two first function heads, two first driving members each having a first engaging section and a first polygonal driving portion extending from the first engaging section corresponding thereto, the two respective first engaging sections being engaged with the two first engaging holes respectively, the two respective first engaging sections being sized to be 10 mm (⅜ inch) and 13 mm (½ inch);
a second wrench having a second handle and two second function heads on two ends of the second handle, two second engaging holes respectively defined in the two second function heads, two second driving members each having a second engaging section and a second polygonal driving portion extending from the second engaging section corresponding thereto, the two respective second engaging sections being engaged with the two second engaging holes respectively, the two respective second engaging sections being sized to be 13 mm (½ inch) and 19 mm (¾ inch), and
a third wrench having a third handle and two third function heads on two ends of the third handle, two third engaging holes respectively defined in the two third function heads, two third driving members each having a third engaging section and a third polygonal driving portion extending from the third engaging section corresponding thereto, the two respective third engaging sections being engaged with the two third engaging holes respectively, the two respective third engaging sections being sized to be 19 mm (¾ inch) and 10 mm (⅜ inch), and

2. The wrench set as claimed in claim 1, wherein each of the first, second and third function heads includes a ratchet mechanism connected thereto.

3. A wrench comprising:
a handle and two function heads on two ends of the handle, two engaging holes respectively defined in the two function heads, and
two of three driving members being engaged with the engaging holes, each of the three driving members having an engaging section for being engaged with the engaging hole, and a polygonal driving portion extending from the engaging section, the three respective engaging sections having three respective sizes of 10 mm (⅜ inch), 13 mm (½ inch) and 19 mm (¾ inch).

4. The wrench set as claimed in claim 3, wherein each of the two function heads includes a ratchet mechanism connected thereto.

5. A wrench comprising:
a wrench having a handle which has a first function head and a second function head connection on two ends thereof, a first engaging hole and a second engaging hole respectively defined in the first and second function heads, a third engaging hole defined through the handle;
three driving members being engaged with the first, second and third engaging holes respectively, each of the three driving members having an engaging section for being engaged with the engaging hole corresponding thereto and a polygonal driving portion extending from the engaging section, the three respective engaging sections having three respective sizes of 10 mm (⅜ inch), 13 mm (½ inch) and 19 mm (¾ inch).

6. The wrench set as claimed in claim 5, wherein each of the first, second and third engaging holes includes a ratchet mechanism connected thereto.
